(19) United States
(12) Patent Application Publication
(10) Pub. No.: US 2024/0042917 A1
(43) Pub. Date: Feb. 8, 2024

(54) TIE DOWN HOOK MAGNETIC REINFORCEMENT DEVICE

(71) Applicant: Marco Robles, Ceres, CA (US)

(72) Inventor: Marco Robles, Ceres, CA (US)

(21) Appl. No.: 17/881,342

(22) Filed: Aug. 4, 2022

(51) Int. Cl. B60P 7/08

(52) U.S. Cl. CPC B60P 7/0807

(57) ABSTRACT

A tie down hook magnetic reinforcement device for stabilizing a tie down hook includes a holster sheathing a magnet. The holster has a first end and a second end. The first end of the holster holds the magnet. The magnet is attaches to a vehicle truck by a magnetic attraction. The second end of the holster has an aperture. A hook is secured to the aperture of the holster. The hook has a first flange and a second flange. The first flange of the hook is nested within the aperture of the holster. The second flange of the hook is fastens to a tie down hook for a tie down strap used in a bed of the vehicle truck.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tie down hook device and more particularly pertains to a new tie down hook device for stabilizing a tie down hook.

### (2) Description of Related Art Including Information Disclosed Under 37 CFR 1.97 and 1.98

The prior art relates to tie down hook devices. The prior art includes a variety of tie down hook devices having a magnet to assist in securing the tie down hook to a vehicle. Known prior art lacks a tie down hook device having a holster sheathing a magnet and being coupled to a hook configured for retaining the tie down hook in place within the bed of the vehicle truck.

### BRIEF SUMMARY OF THE INVENTION

An embodiment of the disclosure meets the needs presented above by generally comprising a holster sheathing a magnet. The holster has a first end and a second end. The first end of the holster holds the magnet. The magnet is configured for securing to a vehicle truck by a magnetic attraction. The second end of the holster has an aperture wherein a hook is secured to the aperture of the holster. The hook has a first flange and a second flange. The first flange of the hook is nested within the aperture of the holster. The second flange of the hook is configured for securing to a tie down hook for a tie down strap used in a bed of the vehicle truck.

Furthermore, a method for reinforcing a tie down hook on a vehicle truck includes the step of attaching the tie down hook of a tie down strap to a latch of an interior of a bed of a vehicle truck. The tie down strap is configured for retaining a variety of items in a fixed position upon the bed of the vehicle truck. The user inserts a second flange of a hook into an opening of the tie down hook, wherein a tip of the second flange secures the hook to the tie down hook of the tie down strap. The user positions a holster of a first flange of the hook against an exterior of the bed of the vehicle truck. A magnet of the holster retains the holster and the hook in a fixed position relative to the vehicle truck, thus the tie down hook is held in a fixed position against the hook. The user fastens a second tie down hook of the tie down strap to the interior of the bed of the vehicle truck, thus securing the variety of items within the bed of the vehicle truck in a fixed position relative to the tie down strap. Subsequently, the user pulls the holster from the exterior of the bed of the vehicle truck prior to removing the second flange of the hook from the opening of the tie down hook.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a tie down hook magnetic reinforcement device according to an embodiment of the disclosure.

FIG. 2 is a side view of an embodiment of the disclosure.

FIG. 3 is an in-use view of an embodiment of the disclosure.

### DETAILED DESCRIPTION OF THE INVENTION

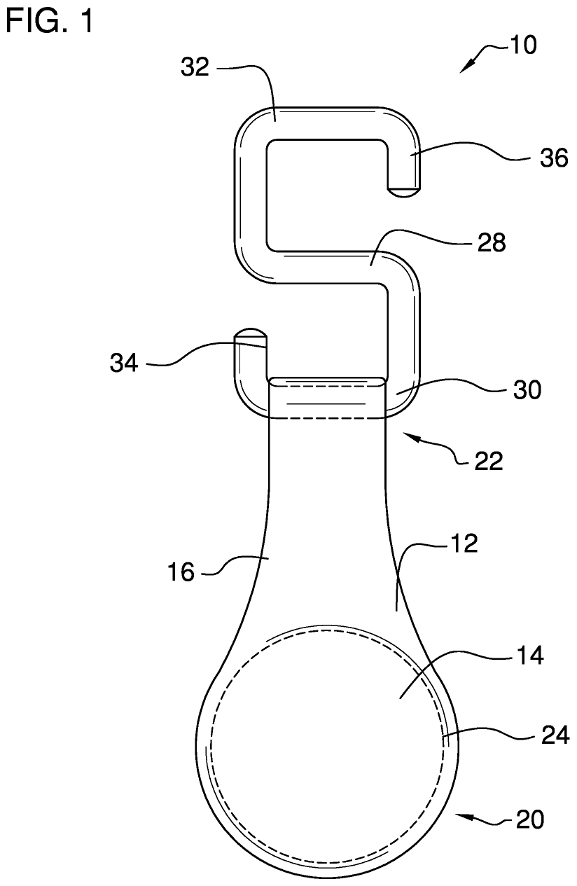

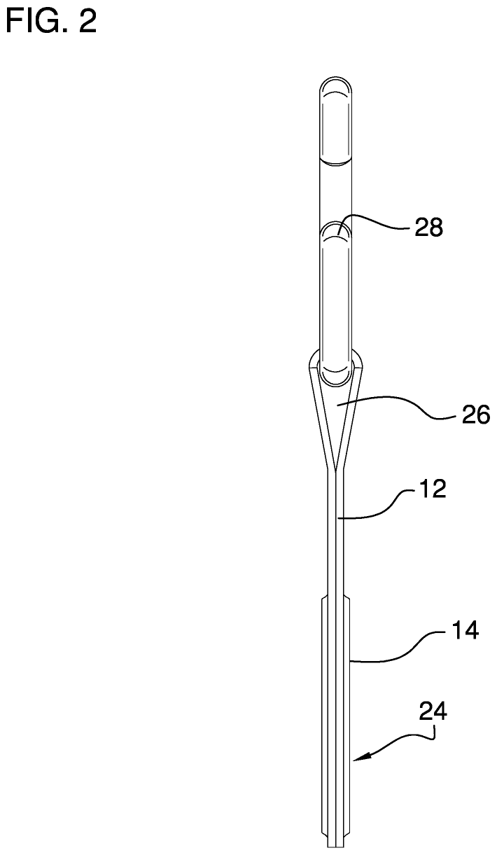

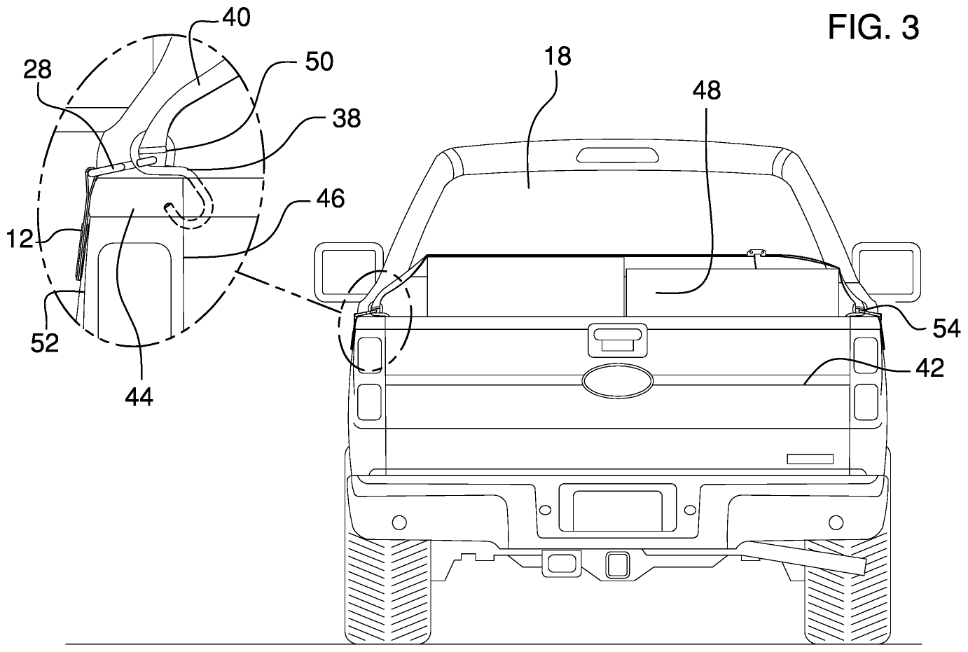

With reference now to the drawings, and in particular to FIGS. 1 through 3 thereof, a new tie down hook device embodying the principles and concepts of an embodiment of the disclosure and generally designated by the reference numeral 10 will be described.

As best illustrated in FIGS. 1 through 3, the tie down hook magnetic reinforcement device 10 generally comprises a holster 12 sheathing a magnet 14. The holster 12 is a leather material 16 being configured for being resistant to tearing and having a soft surface. The leather material 16 is used to prevent any surface damage to a vehicle truck 18. Furthermore, the holster 12 has a first end 20 and a second end 22. The first end 20 of the holster 12 holds the magnet 14. The magnet 14 is nested within a cavity 24 of the holster 12. The magnet 14 is circular and is configured for securing to a vehicle truck 18 by a magnetic attraction. The second end 22 of the holster 12 has an aperture 26 defining a place for an element to be positioned within.

Furthermore, a hook 28 is secured to the aperture 26 of the holster 12, as shown in FIG. 1. The hook 28 is an S hook being configured for having a shape resembling the letter S. In addition, the hook 28 has a first flange 30 and a second flange 32. The first flange 30 of the hook 28 is nested within the aperture 26 of the holster 12. A tip 34 of the first flange 30 of the hook 28 is configured for retaining the hook 28 within the aperture 26 of the holster 12. The tip 34 of the first flange 30 is positioned perpendicular relative to the first flange 30. The second flange 32 of the hook 28 is configured for securing to a tie down hook 38 for a tie down strap 40 used in a bed 42 of the vehicle truck 18. The second flange 32 of the hook 28 has a tip 36 being configured for securing the hook 28 to the tie down hook 38 of the tie down strap 40. The tip 36 of the second flange 32 is positioned perpendicular relative to the second flange 32. The second flange 32 of the hook 28 is configured for being removable from the tie down hook 38 of the tie down strap 40.

In use, the user attaches the tie down hook 38 of the tie down strap 40 to a latch 44 of an interior 46 of the bed 42 of the vehicle truck 18. The tie down strap 40 is configured for retaining a variety of items 48 in a fixed position upon the bed 42 of the vehicle truck 18. The user inserts the second flange 32 of the hook 28 into an opening 50 of the tie down hook 38 wherein the tip 36 of the second flange 32 secures the hook 28 to the tie down hook 38 of the tie down strap 40. The user positions the holster 12 of the first flange 30 of the hook 28 against an exterior 52 of the bed 42 of the vehicle truck 18. The magnet 14 of the holster 12 retains the holster 12 and the hook 28 in a fixed position relative to the vehicle truck 18, thus the tie down hook 38 is held in a fixed position against the hook 28. The user fastens a second tie down hook 54 of the tie down strap 40 to the interior 46 of the bed 42 of the vehicle truck 18, thus securing the variety of items 48 within the bed 42 of the vehicle truck 18 in a fixed position relative to the tie down strap 40. Subsequently, the user pulls the holster 12 from the exterior 52 of the bed 42 of the vehicle truck 18 prior to removing the second flange 32 of the hook 28 from the opening 50 of the tie down hook 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tie down hook reinforcement device configured to magnetically fasten a tie down hook in place within the bed of a vehicle truck, the tie down hook reinforcement device comprising:
a holster sheathing a magnet, the holster having a first end and a second end, the first end of the holster holding the magnet, the magnet being configured for securing to a vehicle truck by a magnetic attraction, the second end of the holster having an aperture; and
a hook being secured to the aperture of the holster, the hook having a first flange and a second flange, the first flange of the hook being nested within the aperture of the holster, the second flange of the hook being configured for securing to a tie down hook for a tie down strap used in a bed of the vehicle truck.

2. The tie down hook reinforcement device of claim 1, further comprising the holster being a leather material, the leather material being configured for being resistant to tearing and having a soft surface.

3. The tie down hook reinforcement device of claim 2, further comprising the magnet being nested within a cavity of the holster, the magnet being circular, the magnet being configured for securing to a vehicle truck a magnetic attraction.

4. The tie down hook reinforcement device of claim 3, further comprising the aperture defining a place for an element to be positioned within.

5. The tie down hook reinforcement device of claim 4, further comprising the hook being an S hook, the S hook being configured for having a shape resembling the letter S.

6. The tie down hook reinforcement device of claim 5, further comprising a tip of the first flange of the hook being configured for retaining the hook within the aperture of the holster, the tip of the first flange being positioned perpendicular relative to the first flange.

7. The tie down hook reinforcement device of claim 6, further comprising the second flange of the hook having a tip, the tip of the second flange being configured for securing the hook to the tie down hook of the tie down strap, the tip of the second flange being positioned perpendicular relative to the second flange.

8. A tie down hook reinforcement device configured to magnetically fasten a tie down hook in place within the bed of a vehicle truck, the tie down hook reinforcement device comprising:
a holster sheathing a magnet, the holster being a leather material, the leather material being configured for being resistant to tearing and having a soft surface, the holster having a first end and a second end, the first end of the holster holding the magnet, the magnet being nested within a cavity of the holster, the magnet being circular, the magnet being configured for securing to a vehicle truck by a magnetic attraction, the second end of the holster having an aperture, the aperture defining a place for an element to be positioned within; and
a hook being secured to the aperture of the holster, the hook being an S hook, the S hook being configured for having a shape resembling the letter S, the hook having a first flange and a second flange, the first flange of the hook being nested within the aperture of the holster, a tip of the first flange of the hook being configured for retaining the hook within the aperture of the holster, the tip of the first flange being positioned perpendicular relative to the first flange, the second flange of the hook being configured for securing to a tie down hook for a tie down strap used in a bed of the vehicle truck, the second flange of the hook having a tip, the tip of the second flange being configured for securing the hook to the tie down hook of the tie down strap, the tip of the second flange being positioned perpendicular relative to the second flange.

9. A method for reinforcing a tie down hook on a vehicle truck, the method including the step of:
attaching the tie down hook of a tie down strap to a latch of an interior of a bed of a vehicle truck, the tie down strap being configured for retaining a variety of items in a fixed position upon the bed of the vehicle truck;
inserting a second flange of a hook into an opening of the tie down hook, a tip of the second flange securing the hook to the tie down hook of the tie down strap;
positioning a holster of a first flange of the hook against an exterior of the bed of the vehicle truck, a magnet of the holster retaining the holster and the hook in a fixed position relative to the vehicle truck; the tie down hook being held in a fixed position against the hook;
fastening a second tie down hook of the tie down strap to the interior of the bed of the vehicle truck, securing the variety of items within the bed of the vehicle truck in a fixed position relative to the tie down strap; and
pulling the holster from the exterior of the bed of the vehicle truck, removing the second flange of the hook from the opening of the tie down hook.
